(19) United States
(12) Patent Application Publication
(10) Pub. No.: US 2014/0026155 A1
(43) Pub. Date: Jan. 23, 2014

(54) Apparatus for managing, storage, securing, delivering, and tracking energy and communication transactions

(71) Applicants: David Valin, Concord, CA (US); Alex Socolof, Briarcliff Manor, NY (US)

(72) Inventors: David Valin, Concord, CA (US); Alex Socolof, Briarcliff Manor, NY (US)

(21) Appl. No.: 14/034,351

(22) Filed: Sep. 23, 2013

Related U.S. Application Data
(63) Continuation-in-part of application No. 13/721,116, filed on Dec. 20, 2012.
Application No. 13/721,116 is a continuation of application No. 12/768,981, filed on Apr. 28, 2010, now Pat. No. 8,369,997.
Application No. 12/768,981 is a continuation-in-part of application No. 12/830,344, filed on Jul. 4, 2010.
Application No. 12/830,344 is a continuation-in-part of application No. 12/459,353, filed on Jun. 29, 2009.

(51) Int. Cl. G01D 4/00; H04N 21/2543

(52) U.S. Cl. CPC G01D 4/002; H04N 21/2543
USPC 725/5; 340/870.02

(57) ABSTRACT

The apparatus is an alternative energy wireless solar panel wind turbine communication server appliance node mechanism with built in communications server array, wireless energy and communications mechanism with protection, sharing, storage, accessing, authentication, battery management, certification, processing attachment and tracking mechanisms. The apparatus for energy generation and transfer is utilized via networked servers, solar panels, light and wireless electronic devices (online network and offline network) as well as mobile (wireless) communications devices built into one waterproof, temperature, controlled self-sensing hardware package. The apparatus also works as part of a kilowatt hour banking system, a portable energy mobile system, and apparatus for energy transferable to a KWH Bank ATM, and/or to another solar server nodes utilizing light.

### CROSS REFERENCE TO RELATED APPLICATIONS

This application claims priority from and is a Continuation in Part of U.S. patent application Ser. No. 13/721,116 entitled “Solar Panel Wind Turbine Communication Server Network Apparatus Method and Mechanism” filed on Dec. 20, 2012, which claims priority from and is a continuation of U.S. patent application Ser. No. 12/768,981 entitled “Solar Panel Wind Turbine Communication Server Network Apparatus Method and Mechanism” filed on Apr. 28, 2010, now issued U.S. Pat. No. 8,369,997, is incorporated by reference in its entirety for all purposes as if fully set forth herein.

U.S. patent application Ser. No. 13/721,116 claims priority from and is a continuation of U.S. patent application Ser. No. 12/768,981, entitled “Solar Panel Wind Turbine Communication Server Network Apparatus Method and Mechanism”, filed on Apr. 28, 2010, now issued U.S. Pat. No. 8,369,997, which is incorporated by reference in its entirety for all purposes as if fully set forth herein.

This application claims priority from and is a Continuation in Part of U.S. patent application Ser. No. 12/830,344 entitled “Apparatus for Secure Recording and Transformation of images to Light for identification, and Audio Visual Projection to Spatial Point Targeted Area” filed on Dec. 17, 2009.

U.S. patent application Ser. No. 12/830,344 is a Continuation in part of U.S. patent application Ser. No. 12/459,353 entitled “Method and Mechanism for Protection, Sharing, Storage, Accessing, Authentication, Certification, Attachment and Tracking Anything in a Network” filed on Jun. 29, 2009, and is a Continuation of U.S. patent application Ser. No. 12/653,749 entitled “Method and Mechanism for Identifying, Protecting, Requesting, Assisting, and Managing Information” filed on Dec. 17, 2009, which are all incorporated by reference in their entirety for all purposes as if fully set forth herein.

### FEDERALLY SPONSORED RESEARCH

Not Applicable

### SEQUENCE LISTING OR PROGRAM

Not Applicable

### TECHNICAL FIELD OF THE INVENTION

The present invention relates to an independent solar panel wind turbine communication server appliance network of nodes connected together to form a powerful energy network for communications and energy needs. The method and mechanism system has several remote management aspects plus a special metering system for kilowatt hours and thermal temperatures.

### BACKGROUND OF THE INVENTION

The use of solar panels for daylight energy creation is very wide spread, and has limited ability to store energy, transfer energy, and bank energy. This system apparatus provides single node use, management of transfers of electricity, data and communications, and identification of the rightful owner of above said commodities.

The present invention relates to an independent solar panel wind turbine communication server appliance network of nodes connected together to form a powerful energy network for communications and energy needs. The apparatus disclosed here has several remote management aspects plus a special metering system, energy transferable, light weight portable mobile energy battery storage, for storage and transfer of kilowatt hours to another node, for storage and use, or deposited into an ATM for sale to another Solar server node.

The need for this kind of system is a growing need as the electric energy grid is an aging grid and as time goes by there will be a need for no single point of failure systems implemented. The system apparatus presented here would be an inexpensive alternative energy system, with many energy creation node points. Because of the ability of this smart system apparatus, places that do not have an energy grid around the world can now have an inexpensive dependable no single point of failure, and low pollution energy creation. And in the event of global warming storms, and infrastructure disruptions this system can get power and communications back very quickly in mobile framework.

### DEFINITIONS

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “QR Code”, abbreviated from and also known as “Quick Response Code”, is defined as a type of matrix barcode, or two-dimensional code, used for commercial tracking, entertainment and transport ticketing, product marketing, and in-store product labeling.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as “webpage” is a document, typically written in plain text interspersed with formatting instructions of Hypertext Markup Language (HTML, XHTML). A web page may incorporate elements from other websites with suitable markup anchors.

“Web pages” are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“NFC” is an acronym for “Near Field Communication” which allows for simplified transactions, data exchange, and wireless connections between two devices in proximity to each other, usually by no more than a few centimeters. NFC is expected to become a widely used system for making payments by smartphone in the United States. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than using the actual credit card.

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

### SUMMARY OF THE INVENTION

The present method and apparatus of the present invention is a solar panel wind turbine comprising a communication server appliance network with one or more nodes meets the needs of the alternative energy user by providing many additional positive features to reduce the energy cost for the user and reduce drain on the conventional energy grid by the user. The present invention also teaches added features for the user to be able to have an additional source of power, and communication just in case the traditional energy grid goes down.

With new more efficient solar panels coming on line, there is a great deal of energy that the grid cannot handle. The present invention provides for the storage and distribution of energy through an energy mesh network, and KWH bank ATM system.

The purpose of the present invention is to create a lightweight and portable energy and communications grid option for rural areas, and non-grid systems. Each node has the ability to store energy, transfer energy, utilizing programmed criteria for energy and communications transactions.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the Second Layer Communications Control of the present invention;

FIG. 2 illustrates the First Layer Energy Storage and Control of the present invention;

FIG. 3 illustrates the Third Layer Solar Panel and Wind Turbines of the present invention;

FIG. 4 illustrates the Generator assembly with the starter and motor stabilizer devices;

FIG. 5 illustrates the Graphene Alginate biodegradable Capacitor energy storage of the present invention;

FIG. 6 illustrates the Light energy transfer and storage management device of the present invention;

FIG. 7 illustrates the Mobile conductor energy transfer to ATM device of the present invention;

FIG. 8 illustrates the Solar panel wind turbine communication server Spatial Point mounting device of the present invention;

FIG. 9 illustrates the Human Key with additional pattern extractor identification device, 3D object measurement Device, And Spatial Point Verification Device of the present invention;

FIG. 10 illustrates the Solar panel wind turbine communication server adaptable solar concentrator device, with spatial point intensity identification and targeting manager controller of the present invention; and

FIG. 11 illustrates the Surface Light Intensity Manager Controller and spatial point light sensor apparatus of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-user network; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents. Now referring to the Figures, the embodiment of the method of the present invention is shown.

The apparatus of the present invention provides a plurality of graphene anode cathode capacitor electricity storage and transfer devices that are light weight, mobile, and provide static storage units. The present invention accomplishes this by utilizing a capacitor high density storage bank of batteries. These are supercapacitor batteries, made of graphene electrodes, anodes, and cathodes. And this further comprises, where the battery packs have transmission of communications, and energy in a mobile movable container. The apparatus presented here also provides a plurality of data, and communication storage combined in the capacitor battery pack, for the purpose of being able to transfer energy, data, and communication in the same mobile package.

The capacitor battery pack in this solar panel wind turbine communication server appliance network node is made up of a plurality of capacitor cells, for storage, that have an infrared or other color light bands light receiver, transmitter included with a WiFi Radio transmitter, and receiver. The energy, data, and communication storage cells are made from graphene anodes, diodes separated by a gel electrolyte.

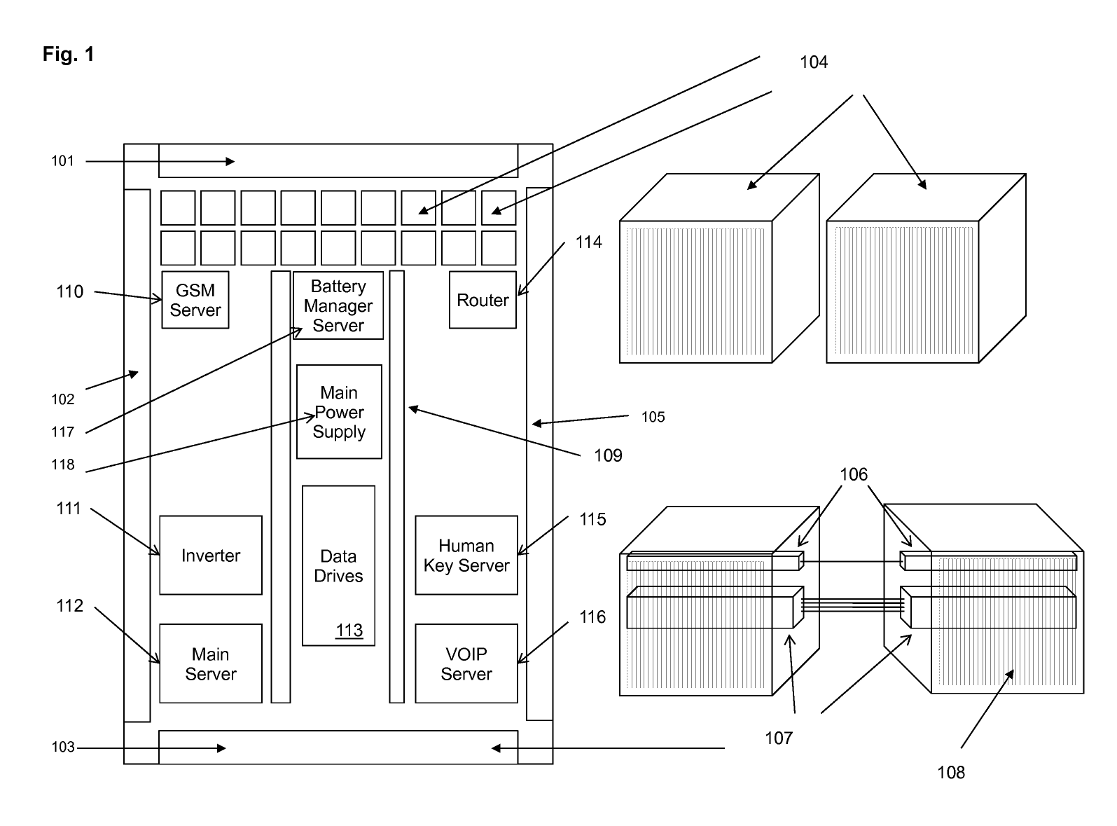

Now referring to FIG. 1, the second layer communication control is illustrated. A plurality of graphene capacitor electricity storage batteries 104 and 108 are located adjacent to a GSM server 110 battery manager server 117, router 114, main power supply 118, inverter 111, main server 112, data drives 113, human key server 115, and a VOIP server 116. The computer hardware is arranged around a plurality of thermal sensing strips 109, and is mounted to a wind turbine tray 102 and 105 that allows for in and out motion as well as moveable data energy trays 101 and 103 that also enable in and out motion. Laser energy transfer transmitters and receivers 107 and 106 provide for the transmission and receive of energy between the graphene super capacitor storage batteries 108.

The apparatus also provides for the ability to be able to transmit energy, data and communication through light to other solar server nodes, as well as from the mobile battery pack described above, utilizing multiple laser transmission to a specific receiving device spatial point target.

The light transferal apparatus is mounted near the near field electricity transmitters and receivers, on each solar server node, so that along with transfer of energy with near field processes, there is provided light transference of energy, data and communications between the nodes.

A further device in the apparatus, is the separate sensing, management, and mobile battery pack that has the ability to be portable, with energy, data, or communications added to it remotely, with light transfer, wireless transfer, or a plugged in wired transferal. This mobile battery pack can provide a connection to a KWH Bank or an ATM Baking device for instant payment transactions, storage of energy, deposits of energy, transfer of energy, withdrawals of energy, or for sharing energy in transactions through other solar server nodes.

Another aspect and device of the apparatus of the present invention, is the capacitor batteries used in the system. These devices have a plurality of graphene based storage cells, which have a biodegradable replaceable function. This is for the purpose of cutting down on the pollution of regular conventional batteries. Also this device has the ability to charge and discharge very rapidly.

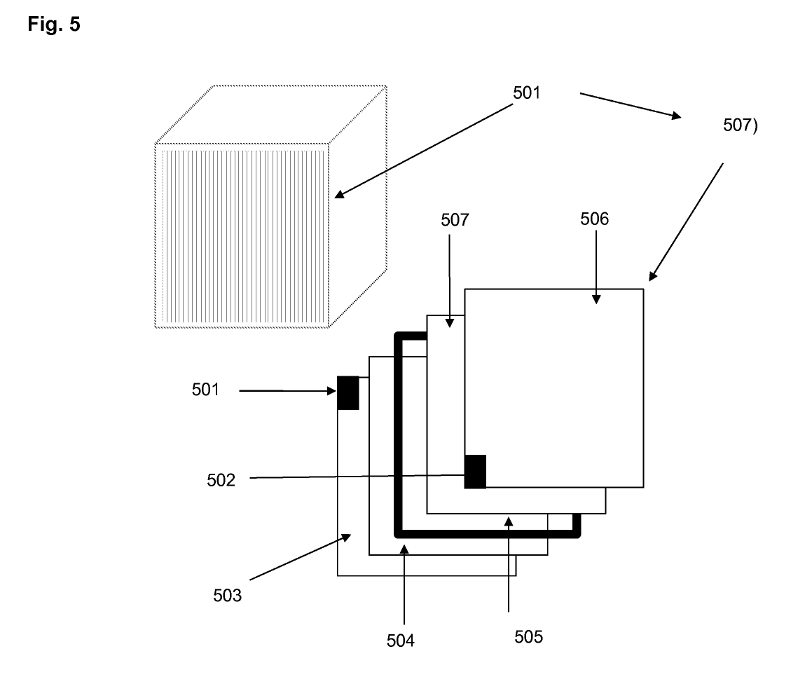

FIG. 5 illustrates a graphene alginate bidegradable super capacitor energy storage device. In each battery 500, there are two hundred combined super capacitor storage cells 507. A single capacitor storage cell 507 is comprised of a graphene cathode layer 506 with a positive cathode connector 502 over a alginate polymer layer 507, over a biodegradable electrolyte layer 505 over an alginate polymer layer 504, over a graphene anode layer 503 with a negative anode connector 501. Alginate polymer extracted from brown seaweed may be used for the alginate polymer layer 504. The biodegradable electrolyte layer 505 is made up of either a sugar based polymer of Agara, Agar, Guar Gum, Carrageen, or natural rubber with a suspension of phosphoric acid, and graphene particles.

All energy, data, and communications aggregating has the smart capacitor graphene batteries used for storage, transactions, with distribution to all other nodes, and the mobile battery pack. Also all storage, and distribution methods in the apparatus have a Human Key security mechanism implemented, managed through the central Human Key server in the Solar Wind Turbine server apparatus mobile or statically placed.

The statically placed Solar Wind Turbine Server Apparatus utilizes the spatial points of all four corners of the device to be able to provide a 19th redundancy to the 18 redundancies of the Human Key security system. In the Mobile Solar Wind Turbine Server Apparatus this spatial point security mechanism is connected to a GPS server for dynamic spatial point target aggregation and use. The reason for this function is that if the Solar Wind Turbine Server Apparatus is moved in the static application, all the important data is rendered useless. In the Mobile Solar Wind Turbine Server Apparatus a set criteria can be programmed into the apparatus Human Key Server that records the appropriate spatial point targets that the mobile device can be securely used.

In the apparatus, each Solar Wind Turbine Server has a micro grid of batteries built into the system, for storage, distribution, and use by the system or other node systems. A smart solid state transformer for electricity routing is also used in the system apparatus, for conversions of energy from DC to AC, and smart distribution as related to transactions setup by a Digital Semantic Agent device, that makes decisions related to a programmed criteria for utilizing the five Human Senses to determine when to stop aggregating energy, and to empty capacitor batteries throughout the operation of the apparatus.

The apparatus utilizes a plurality of Over Flow “Full” battery router devices, for the purpose of wireless, or with light sending data to a mobile device, hand held computer, or another solar wind turbine server apparatus node. By doing this the digital semantic agent can communicate with each node, and battery pack it is sending and receiving energy, data, and communication to other nodes.

The Apparatus presented here has a much larger capacity main battery bank of capacitor batteries for the purpose of use within a structure, for distribution, or use in a mobile vehicle. The apparatus further comprises infrared, near field, and/or light energy, data, and communications transfer devices, for the purpose of being able to not only make mobile, and make transferable energy that is created in the system, but to be able to store and make transferable data, and communication to other Solar Wind Turbine Server Apparatus nodes.

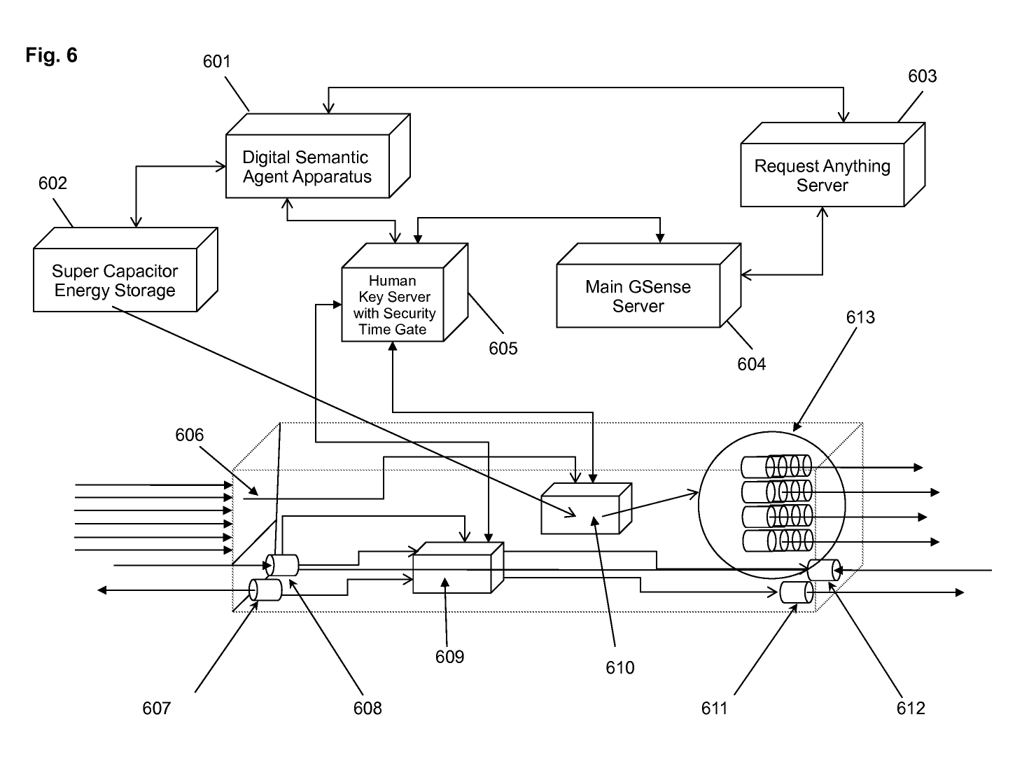

Now referring to FIG. 6, the light energy transfer and storage management devices are illustrated. A human key server with security gate time gate 605 is connected to a main server 604 that communicates with a request server 603. The request sever also communicates with a digital semantic agent 601 that communicates directed with the human key server 605 and the super capacitor energy storage 602. The super capacitor energy storage device 602 receives solar photo voltaic energy from the receiver 606 via an energy storage and transfer manager 610 which also communicates directly with the human key server 605. The energy storage and transfer manager 610 is comprised of laser diodes (405 nm 100 mw) as energy transmitters 613. A data storage and transfer manager 609 receives input from a cadmium sulfide photoresistor data receiver 608 and laser diodes (405 nm 100 mw) acting as data transmitters 607. The data storage and transfer manager 609 communicated directly with the human key server 605 and processes output through laser diodes (405 nm 100 mw) acting as data transmitters 611 and a cadmium sulfide photoresistor acting as a data receiver 612.

An identification controller device is provided for detection, and identification, of electricity, data and communications. Mainly identification of who the owner is, for electricity, data and communications transmitting and receiving, with security, certification, tracking and KWH Bank management integration. The identification controller is connected wired and wireless to a smart light sensing, and redirecting mirror apparatus that is mounted, or separately mounted on the system apparatus and/or directly on the Wind Turbine main shaft along with wind speed sensor. This device takes data from a surface mounted sensor grid, that aggregates temperature, and light intensity on the surface at specific spatial point targets with mapped sensors, of a conventional solar panel. And determines what angle the rotating mirrors need to rotate up, down, left and right to concentrate solar light at the highest efficiency for Solar electricity aggregation. The reason for this device being required in the system, is that the Sun is located in different parts of the sky, and gives maximum energy aggregation for limited periods of the day. By having the smart solar concentrator mirror as part of this system the apparatus will produce energy at optimum levels throughout the whole day. Also this system counteracts for angle of light concentration, and increases the efficiency of a standard solar panel dramatically.

Alternately the wind speed sensor aspect of the apparatus, helps the main controller to make the decision to extend the wind turbines or retract them in inclement weather, or non-wind events.

The apparatus also includes a solar concentrator system robotic mirror mechanisms that includes a servo for left to right movement, a servo for up and down movement, a servo for retraction to storage of the solar concentrator, combined with curved or flat mirrors for reflecting targeted solar concentration of light to spatial point targets on the surface of a solar panel, or PV Photo Voltaic Solar Collector, an infrared or visible light laser diode distance evaluator device, an infrared or visible light laser diode energy transmitter, and an infrared or visible light laser diode energy receiver. The purpose of this addition to the system apparatus is for even distribution of light, increasing the energy created, transmissions of energy, data, and communications, and for generating energy when there is no light available.

The apparatus provides a night time laser concentrator projection apparatus for creating energy from low powered visible light and infrared light lasers, at night for additional energy creation, transformation, transmitting and receiving of energy. And further comprises a plurality of infrared or visible light transmission devices for transmitting light to a receiver for the purpose of transforming electricity to light and transmitting to a receiver that transforms light back into electricity, data, and communication.

An integrated circuit KWH Kilowatt Hour Bank current energy commodity price evaluator device manager is also provided connected to the main controller, the GSM server, RFID device and the wireless router device connected on line, Internet, or satellite receiver for the purpose of aggregating current data related to current prices of energy, data and communications so that the system apparatus can make better decisions on transferal, and receiving energy, data, and communications into and out of the system. Included in this device, utilizing spatial point targets aggregated during the installation process of the static system and GPS coordinates established dynamically in the mobile Solar Wind Turbine Server Apparatus is an identification manager apparatus, that utilizes data from the Human Key server to provide identification of the rightful owner of the Solar Wind Turbine Server Apparatus. This identification manager apparatus, works with energy, data, communications, and identification of administrators throughout the system apparatus, and other Solar Wind Turbine Server Apparatus node systems.

The Solar Wind Turbine Server Apparatus system also provides a mobile, hand held manager device, that works with devices that are not connected to the system network, by providing an “off the grid” integrated circuit security switch device that can be installed in hardware for mobile phone, or hand held application for the purpose of easily switching from standard grid services to Solar Wind Turbine Server Apparatus system off grid services.

The apparatus presented here improves the original design of the Solar Wind Turbine Server Apparatus by having wind turbines within the system consisting with robotic mechanisms for retraction and expansion, a plurality of generators for greater aggregation of energy at night and on windy days, a magnetic revolution stabilizer, and electric motor mechanism for when the wind is not so great to still aggregate energy. The system apparatus presented here also provides additional energy creation utilizing photo voltaic smart wind turbine blades that generate additional electricity from light, mode of materials such as graphene, and other light-weight materials.

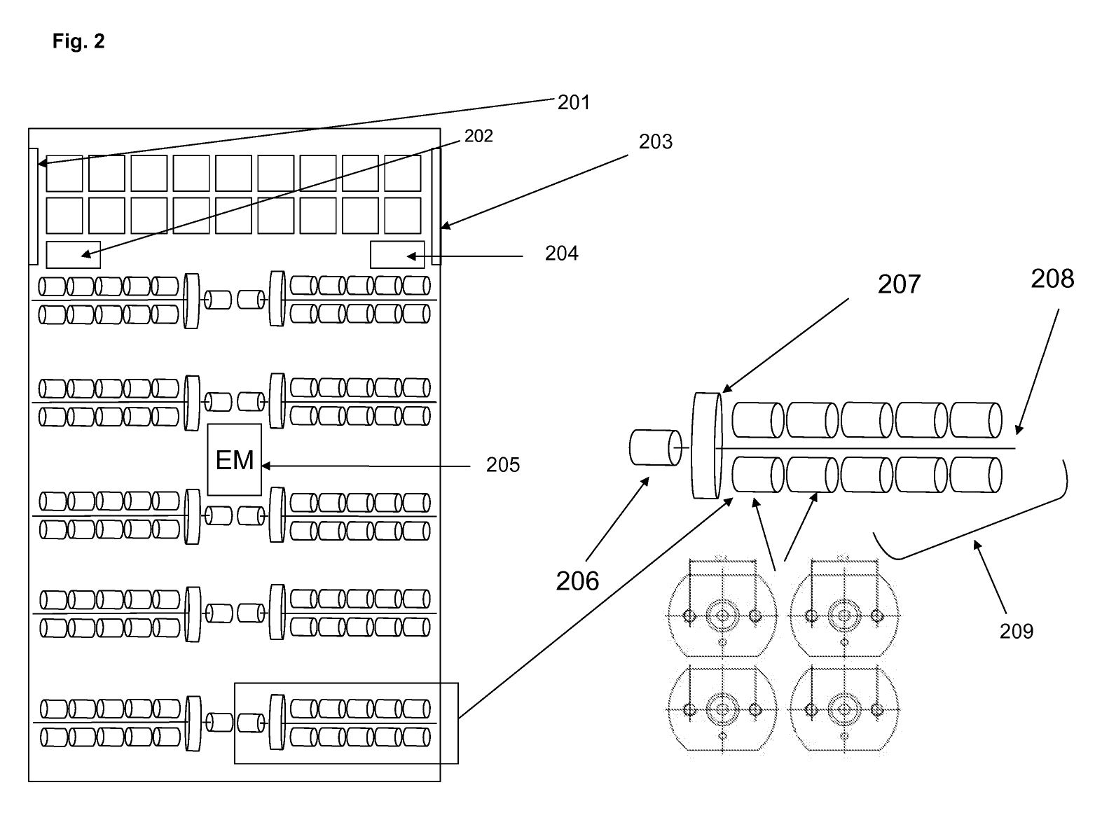

Referring to FIG. 2, the first layer energy storage and control is shown. A near field transmitter induction coil antennae 201 connects to a near field transmitter PCB 202 and near field receiver induction coil antennae 203. Five rows of four generators 209 are arranged around an energy management server controller 205. A motor 206 is connected to a magnetic stabilizer 207 and wind turbine generator shaft 208 which runs between the generators 209.

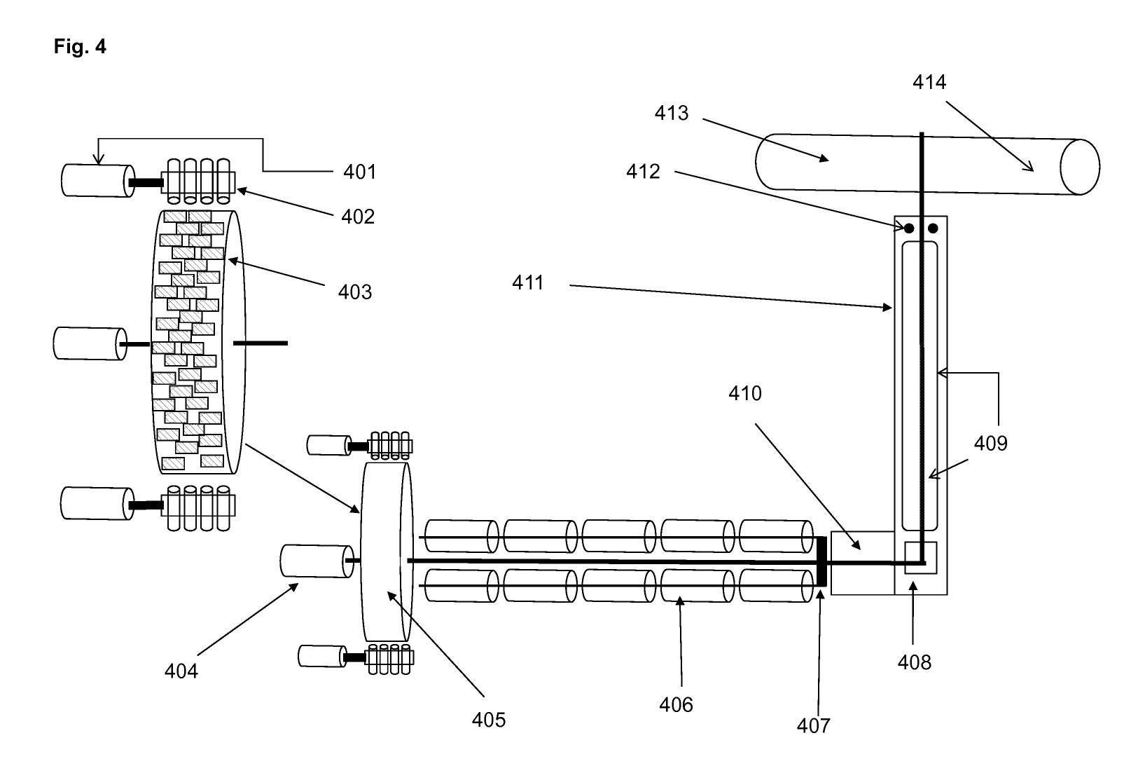

FIG. 4 illustrates the generator assembly. The motor starter 404 can engage and disengage from the magnetic stabilizer. The magnetic stabilizer is comprised of a plurality of servos 401 which are attached to a plurality of multiple rotating magnets 402 which are positioned around a rotating ring with multiple metal spaced points 403. The motor and stabilizer are connected to the shaft 419, which runs between the plurality of generators 406 to a gear 407. At the gear, a wind turbine drive shaft retractor apparatus 410 attaches to a right angle gear box 408 enables the shaft to run perpendicular to its original direction. The shaft 409 which extends form the gear box 408 is retractable and fitted with light sensors 412 as well as satellite receivers and transmitters. The light sensors 412 determine where the sun is or at night were infrared light may be located. The wind vanes 414 are made of graphene solar panels for strength and additional energy creation.

Additionally light sensors, and wind speed sensors are deployed on the wind turbine shaft assembly, aggregating date for the main Solar Wind Turbine Server Apparatus controllers.

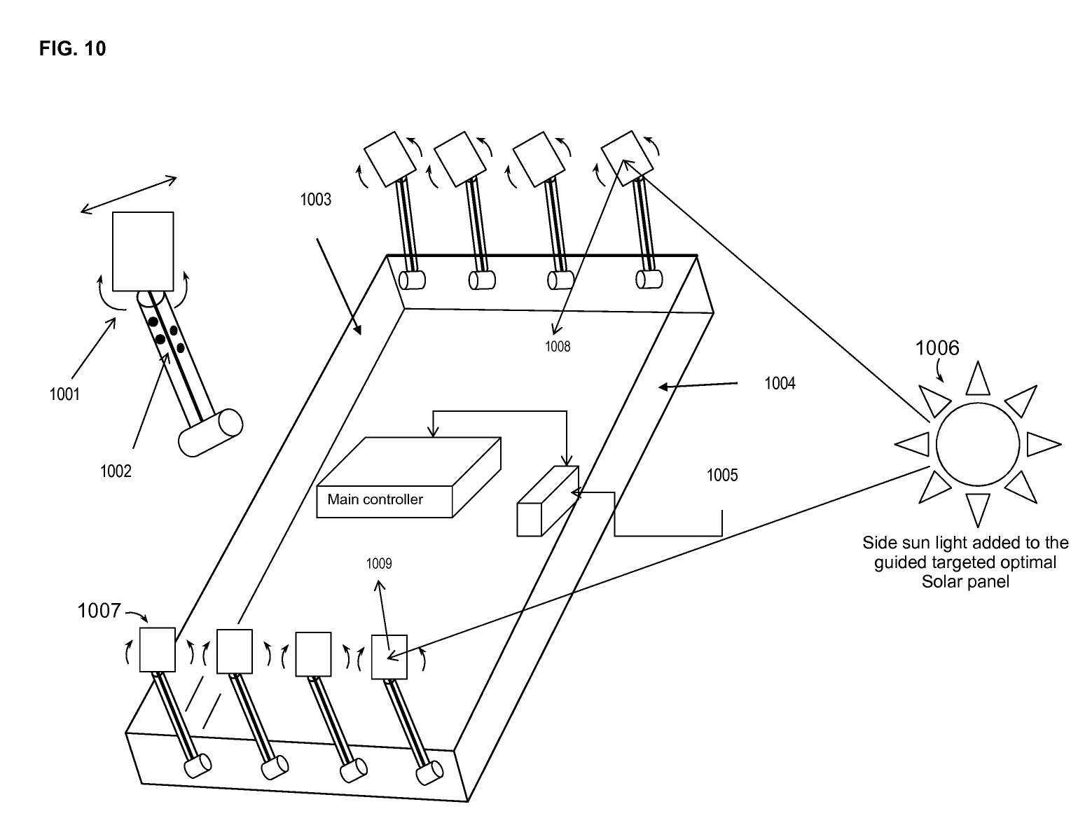

Now referring to FIG. 10, the solar panel wind turbine communication server adaptable solar concentrator component with spatial point intensity identification and targeting manager controller is illustrated. The retractable tray is located at top and bottom of the solar hardware box 1000, and the tray moves in & out expanding the solar mirror concentrators, as managed by the surface light intensity controller 1005 for optimal light concentration at specific spatial points 1008 and 1009. An induction receiver 1003 is located on one side length of the box 1000 and an induction transmitter 1004 is located on an opposing side length of the box 1000. Wind turbine shafts 1007 have light sensors 1002 for peak sunlight identification and also have satellite receiver and transmitter built into the retractable shaft assembly. The shaft can rotate up, down, left, right, 1001 to guide sunlight 1006 to the mirror concentrator 1008 and 1009 at an optimal angle for best intensity generation.

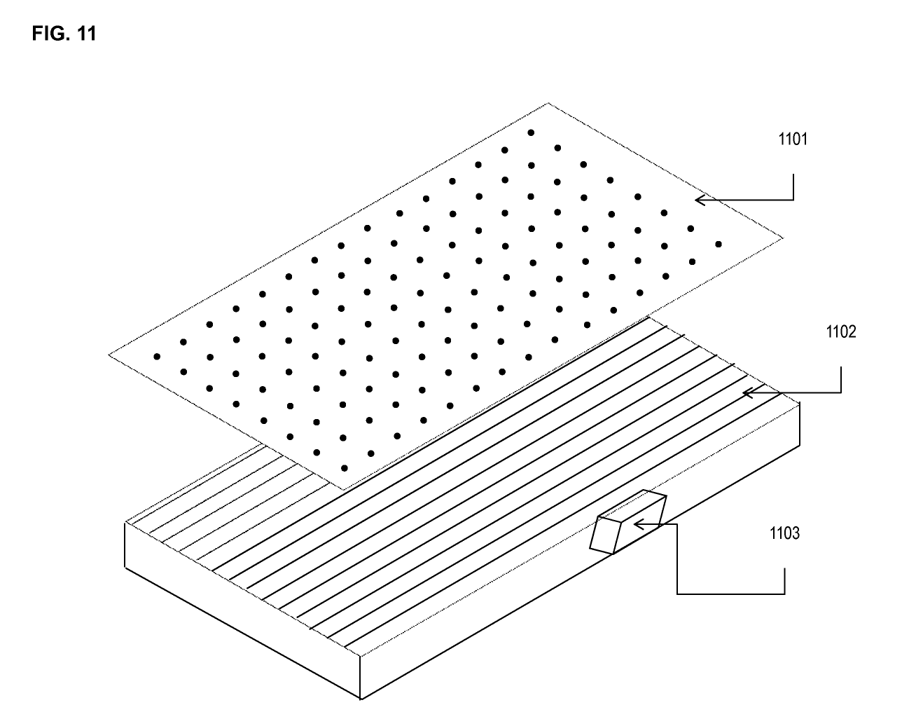

Now referring to FIG. 11, the surface light intensity manager controller and spatial point light sensor device is illustrated. Visible and Infrared light hits the solar panel 1102 where the surface of the solar panel is covered by a thin film layer 1101. An intensity measurement is made at a plurality of spatial point targets sending information back to the surface light intensity manager controller 1103 to control the angles of sunlight coming from the plurality of robotic mirror light concentrators that rotate left, right, up, and down. Infrared light is converted into electricity during the process for additional aggregation.

The apparatus can also further be comprised of a value decision integrated circuit as an integral part of the KWH Banking system consisting of, a request anything transmitter and receiver device, a WiFi wireless transmitter and receiver, a data storage device, a communications VOIP connection device, connected to a capacitor electricity storage evaluator mechanism device, and a solar and wind server network capacity device for evaluation of nearest surplus energy, communication or data. This is accomplished with the laser light communicator device which is used for communicating with nearby Solar Wind Turbine Server Apparatus nodes.

Added into this previously described system apparatus is a laser energy transfer device, working in coordination with the near field energy transfer device, and identifying permissions utilizing the human key security and identification device for the purpose of electricity identification of rightful owner, and routing of energy, data, and communication processes through the touting transformer apparatus.

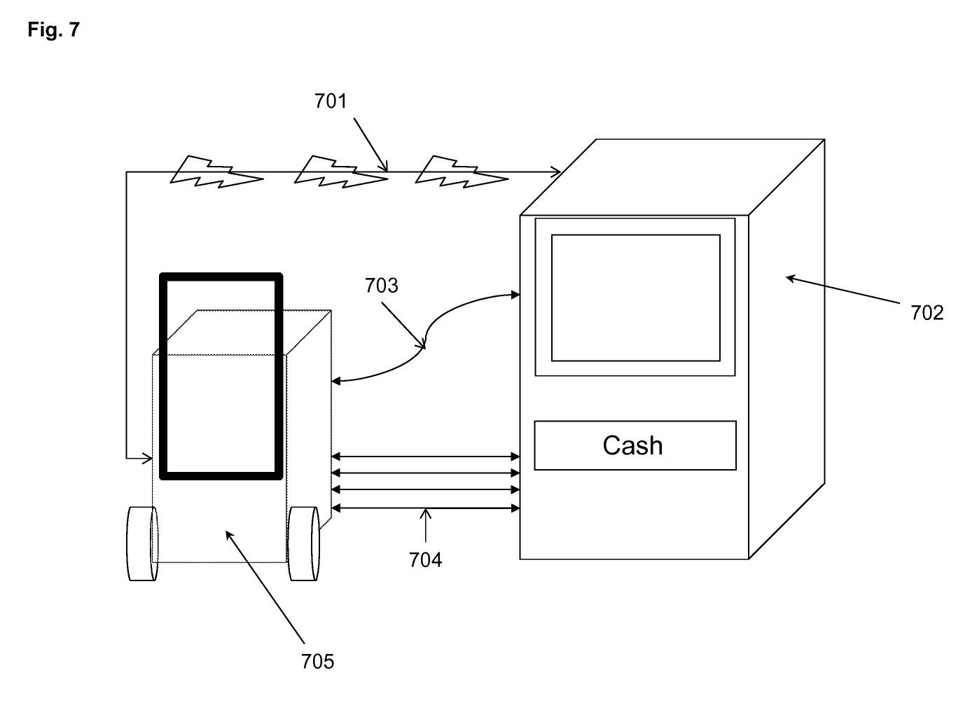

The apparatus of the present invention also includes hardware for KWH Bank energy management, storage, and transactions and an apparatus for connecting to banking ATM machines, or as a standalone ATM machine. Now referring to FIG. 7, a KWH Energy Bank ATM 702 can receive energy transfers either wireless 701, wired 703, or by laser 704 from a mobile KWH Bank ATM Superconductor Battery 705 that charges and discharges in a short time frame, such as single minute.

Integral parts of the KWH Banking system consisting of: a plurality of spatial point corner mounting pole robotic devices that can adjust the Solar Wind Turbine Server Apparatus electronically up and down, controlled by the digital semantic management agent apparatus, including a spatial point, wireless theft detection device, an electricity deposit storage system, an electricity deposit measurement system, an electricity deposit identification of owner system, an electricity deposit manager calculator for current KWH Hour electricity rates, an electricity deposit manager banking payment transaction system, a plurality of capacitor rapid charging and de-charging electricity storage unit apparatus, an electricity withdrawal manager KWH banking payment device, an electricity withdrawal capacitor mobile battery device, an electricity withdrawal connector for vehicles, mobile batteries, and internal energy needs, an electricity deposit and withdrawal donation, investment, and loan device, an electricity KWH Bank collaboration device for transactions with groups of buyer, and sellers embedded in an integrated circuit.

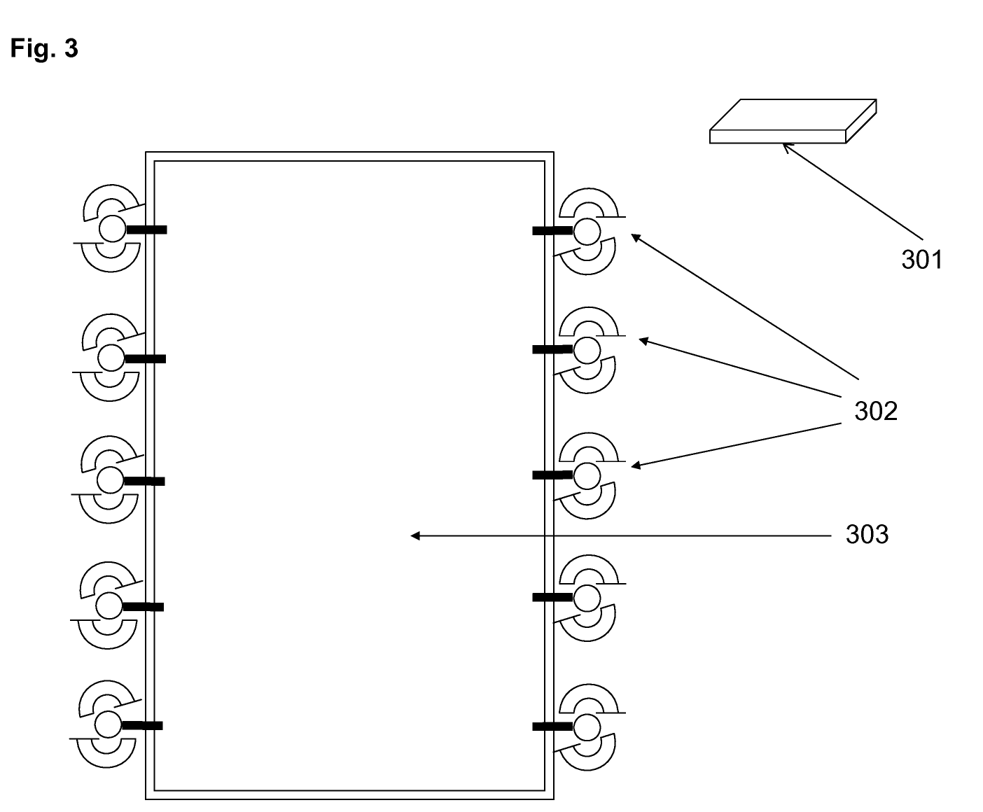

FIG. 3 illustrates the third layer of the solar panel and wind turbine. The solar panel 303 is comprised of a plurality of wind turbines 302, which can also sense the brightness points of light. The handheld digital semantic agent hardware 301 runs the apparatus and can communicate with an administrator by cell phone.

In another embodiment, the apparatus is further comprised of a modular installation kit as an integral part of the Solar Panel Wind Turbine Communication Server Network Apparatus system for secure identified inclusion into already installed Photo Voltaic systems consisting of, a modular install kit for retrofitting already installed PV photo Voltaic panels into the system presented, a plurality of specially Human Key spatial point designed brackets, a plurality of connectors, for evaluations of efficiencies, and registration in the system of previously installed PV Photo Voltaic solar panels by the main controller, a human key attachment of identity to integration of previously installed PV Photo Voltaic solar panels, a management sensing device for calculating different areas of the surface of the solar panels efficiency device, a transparent surface mountable sensor cover, with temperature, and light intensity evaluation device.

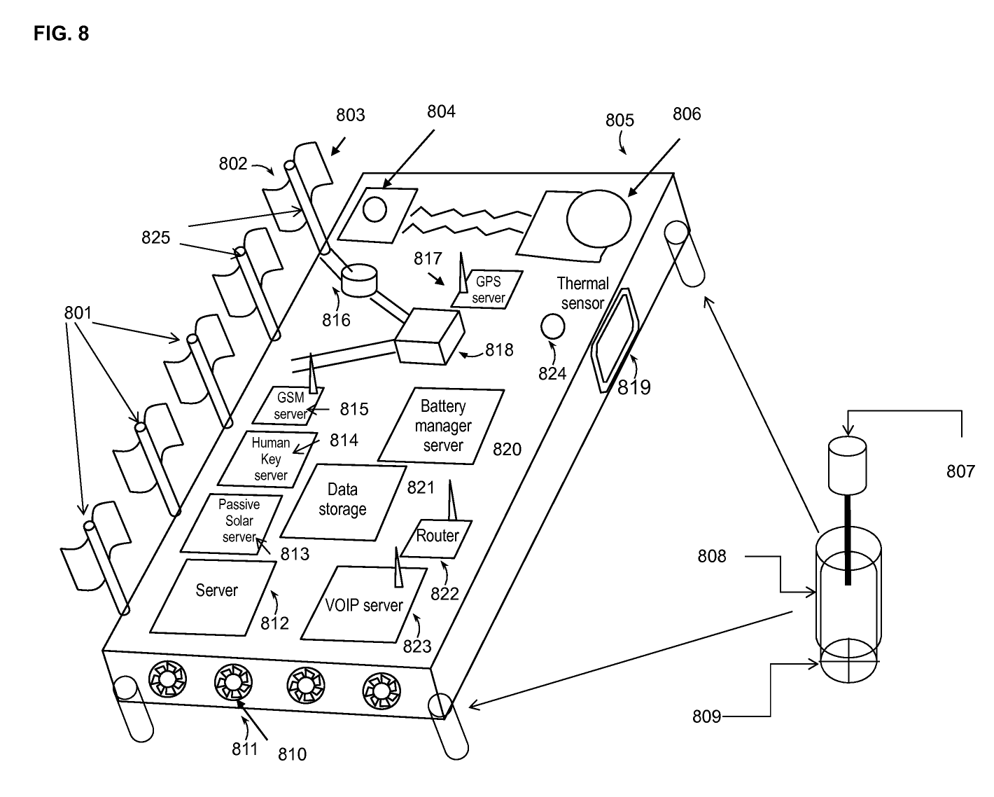

FIG. 8 illustrates the solar panel 805 wind turbine communication server's spatial point mounting components as assembled and combined with the three layers. The solar panel is fitted with a plurality of wind turbines 801 and shafts 825 with light sensors for peak sunlight identification and satellite receivers and transmitters built into retractable assemblies 802. Blades 803 are provided for nighttime power generation. An induction receiver 804 communicates with an induction transmitter 806. The solar panel 805 is comprised of a plurality of generators 817 connected by shafts 816 to the wind turbines collecting power in main power supply 818. A GPS server 817 and GSM server 815 are located adjacent to a human key server 814, battery manager server 820, data storage 821, router 822, VOIP server 823, server 812, and passive solar server 813 for managing and controlling the collection and distribution of power and communications as well as the control of the turbines 802. Low voltage generator fans 811 and 810 keep the computer hardware temperature regulated so that they are not overheated. Up and down leg adjust cylinders 808 are located at each corner to provide automatic adjustment via a servo 807 based on spatial point targets calculated by the GPS server 817 at the time of installation and are attached to the human key server 814 for identification purposes.

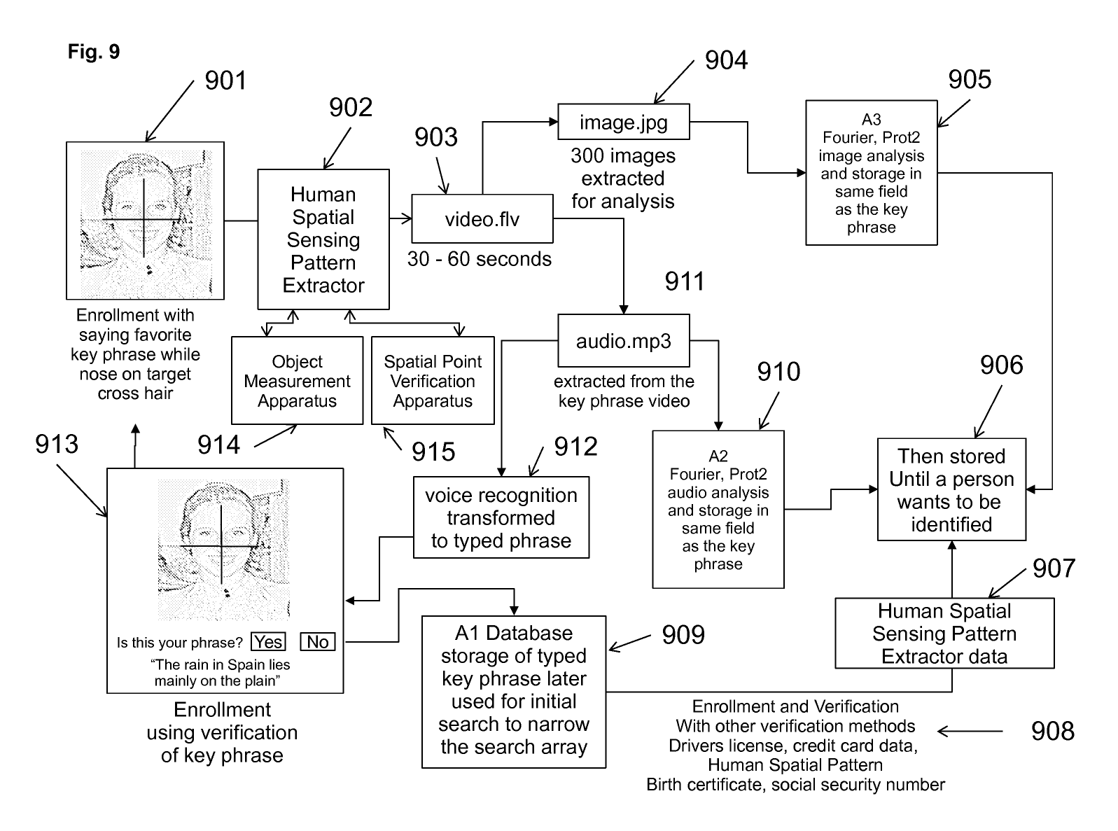

FIG. 9 illustrates the Human Key with additional pattern extractor identification device, 3D object measurement Device, And Spatial Point Verification Device of the present invention. In a first step 901, enrollment of a user by saying their favorite key phrase while having their nose on a target cross hair occurs. Next a human spatial sensing pattern extractor 902 creates a 30-60 second video 903 and provides object measurements 914 and special point verification 915. From the video 903 three hundred images are extracted for analysis 904. And A3 Fourier, image analysis occurs and storage in same field as the key phrase occurs in step 905. Concurrently from the video 903 an audio MP3 is extracted in step 911 form the key phrase video 903 and A3 Fourier, image analysis occurs and storage in same field as the key phrase occurs in step 910. And voice recognition transforms the audio into a typed phrase in step 912. Enrollment using verification of the key phrase next occurs in step 913. The image and audio are stored until a person wants to be identified 906. In step 909 a Database stores the typed key phrase and is later used for an initial search to narrow the search array. Enrollment and Verification With other verification methods such as driver's license, credit card data, Human Spatial Pattern Birth certificate, social security number may occur in step 908. Finally, the human spatial sensing data is extracted in steep 907 and then stored until a person wants to be identified 906.

In another embodiment of the present invention, the graphene photo voltaic device, as an integral part of the Solar Panel Wind Turbine Communication Server Network Apparatus, is further comprised of a graphene top layer, a polymer gel electrolyte graphene middle layer, a second graphene layer synchronized with first graphene layer to get light through put through both layers, and a mirror back bottom layer for reflecting light back through the graphene array of layers for secondary photo electricity creation.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In alternative embodiments, the method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A solar panel wind turbine communication server network apparatus in combination with a computer server, comprising in combination
a plurality of graphene anode cathode capacitor electricity storage and transfer devices;
a plurality of data storage devices;
a plurality of light transmitting and data receiving devices;
a plurality of near field electricity transmitters and receivers;
a capacitor mobile battery pack with wireless and wired connector to provide connection to KWH bank ATM machine for deposit of electricity for instant payment transaction;
a plurality of biodegradable electricity capacitor batteries;
a plurality micro grid of mini sized batteries receiving electricity from solar wind server nodes;
a smart solid state transformer electricity router;
a plurality of electricity over flow “full” battery router devices;
a high capacity main battery bank of capacitor batteries;
a plurality of infrared battery electricity transfer devices;
a plurality of controller devices for detection, and identification of electricity owner for electricity transmitting and receiving, with security, certification, tracking and KWH Bank integration;
a plurality of devices for the purpose of determining highest intensity of energy target from the sun's position in space, and detecting wind patterns;
a plurality of infrared or visible light transmission devices for transmitting light to a receiver for the purpose of transforming electricity to light and transmitting to a receiver that transforms light back into electricity;
a plurality of infrared or visible light transmission devices for transmitting light to a receiver for the purpose of transforming data to light and transmitting to a receiver that transforms light back into data;
a KWH Kilowatt Hour Bank current energy commodity price evaluator;
a plurality of RFIDs;
a spatial point identification;
a human key data access manager; and
a human key administrative access manager.

2. The apparatus of claim 1, wherein the plurality of controller devices are:
a human key light encrypted apparatus;
a spatial point object identification apparatus;
a wireless encryption identification apparatus;
a CODEFA encryption apparatus,
a human sense identification apparatus; and
a server node identification apparatus.

3. The apparatus of claim 1, wherein the plurality of infrared or visible light transmission devices are a laser transmitter cluster apparatus and a photo voltaic receiver apparatus.

4. The apparatus of claim 1, wherein the plurality of devices for the purpose of determining highest intensity of energy target from the sun's position in space, and detecting wind patterns includes:
an intensity of light sensor;
a light sensor;
a wind sensor;
a light spatial point intensity calculator; and
a server node identification apparatus.

5. The apparatus of claim 1, further comprising:
a mobile, hand held manager; and
an “off the grid” integrated circuit security switch device for hardware mobile phone and hand held integration for switching from grid services to off grid services.

6. The apparatus of claim 1, further comprising a plurality battery storage transmission and receiving apparatus consisting of:
a capacitor battery pack with a plurality of capacitor cells;
an infrared or other color bands light receiver;
an infrared or other color bands light transmitter;
a wifi radio transmitter;
a wifi radio receiver;
a plurality of cells made up of graphene gel electrolyte;
a plurality of anodes made of graphene; and
a plurality of diodes made of grapheme.

7. The apparatus of claim 1, further comprising a plurality of solar concentrator system robotic mechanisms consisting of:
a surface solar panel light intensity transparent grid cover with a plurality of spatial point mapped sensors;
a surface solar panel thermal temperature transparent grid cover with a plurality of spatial point mapped sensors;
a servo for left to right movement;
a servo for up and down movement;
a servo for retraction to storage of the solar concentrator; and
a plurality of curved or flat mirrors for reflecting targeted solar concentration of light to spatial point targets on the surface of a solar panel, or PV Photo Voltaic Solar Collector.

8. The apparatus of claim 7, further comprising
an infrared or visible light laser diode distance evaluator device;
an infrared or visible light laser diode energy transmitter; and
an infrared or visible light laser diode energy receiver.

9. The apparatus of claim 1, further comprising a plurality of wind turbines within the system consisting of;
a plurality of robotic mechanisms for retraction and expansion;
a plurality of generators;
a magnetic revolution stabilizer;
an electric motor stabilizer;
a plurality of graphene photo voltaic smart wind turbine blades that generate electricity from light;
a plurality of light sensors; and
a plurality of wind speed sensors;

10. The apparatus of claim 1, further comprising a value decision mechanism as an integral part of the KWH Banking system consisting of;
a request transmitter and receiver;
a WiFi wireless transmitter and receiver;
a data storage;
a VOIP connection;
a capacitor electricity storage evaluator;
a solar and wind server network capacity for evaluation of nearest surplus energy, communication or data;
a laser communicator;
a laser energy transfer device;
a near field energy transfer device;
a human key security and identification device; and
an electricity identification of owner, and routing transformer device.

11. The apparatus of claim 10, further comprising
an KWH Bank energy management, storage, and transaction device for connecting to banking ATM machines, or as a standalone ATM machine as an integral part of the KWH Banking system.

12. The apparatus of claim 11, wherein the KWH Banking system is further comprised of;
a plurality of spatial point corner mounting pole robotic devices that can adjust electronically up and down;
a spatial point, wireless theft detection device;
an electricity deposit storage device;
an electricity deposit measurement device;
an electricity deposit identification of owner device;
an electricity deposit manager calculator for current KWH Hour electricity rates;
an electricity deposit manager banking payment transaction system;
a plurality of capacitor rapid charging and de-charging electricity storage unit devices;
an electricity withdrawal manager and KWH banking payment device;
an electricity withdrawal capacitor mobile battery device;
an electricity withdrawal connector for vehicles, mobile batteries, and internal energy needs;
an electricity deposit and withdrawal donation, investment, and loan device; and
an electricity KWH Bank collaboration device for transactions with groups of buyer, and sellers;

13. The apparatus of claim 1, further comprising a modular installation kit as an integral part of the solar panel wind turbine communication server network apparatus for retrofitting already installed photo voltaic solar panels.

14. The apparatus of claim 13, wherein the modular installation kit is further comprised of:
a plurality of specially designed brackets;
a plurality of connectors, for evaluations of efficiencies of previously installed photo voltaic solar panels;
a human key attachment of identity to integration of previously installed photo voltaic solar panels;
a management device for calculating different areas of the surface of the solar panels efficiency device; and
a transparent surface mountable sensor cover and sensor for temperature and light intensity evaluations.

15. The apparatus of claim 1, further comprising a graphene photo voltaic device as an integral part of the solar panel wind turbine communication server network, consisting of:
a graphene layer;
a first polymer gel electrolyte graphene layer;
a second graphene layer synchronized with the first graphene layer; and
a mirror for reflecting light back through the graphene array of layers for secondary photo electricity creation.

16. The apparatus of claim 15, further comprising a plurality of graphene photo voltaic devices as an integral part of the solar panel wind turbine communication server network.

17. The apparatus of claim 16, wherein the graphene photo voltaic devices as an integral part of the Solar Panel Wind Turbine Communication Server Network Apparatus are comprised of:
a software development kit for devices integrated with system;
a hardware device kit for developers of devices integrated with the system; and
a human key attached to hardware device kit.

18. The apparatus of claim 1, further comprising a mobile version of the the solar panel wind turbine communication server network apparatus.

19. The apparatus of claim 18, further comprising:
a plurality of sensing devices aggregating data back to the main box;
a synchronized hardware manager communicating with the main box; and
a hardware digital semantic agent for making decisions with the main box.

20. The apparatus of claim 1, further comprising:
a plurality of sensing devices aggregating data back to the main box;
a synchronized hardware manager communicating with the main box; and
a hardware digital semantic agent for making decisions with the main box.

21. The apparatus of claim 1, further comprising:
a satellite transmitter and receiver.
the satellite transmitter and receiver:
de-scrambling an encrypted signal;
taking a digital signal and converting it into an analog format;
extracting individual channels from a larger satellite signal;
keeping track of pay-per-view programs;
periodically communicating to a computer at the provider's headquarters to communicate billing information; and
recording, storing, and distributing video.
